(19) United States
(12) Patent Application Publication
(10) Pub. No.: US 2005/0209939 A1
(43) Pub. Date: Sep. 22, 2005

(54) Automated international tax planning method and system

(76) Inventors: Gratian A. Joseph, Pacifica, CA (US); Donald D. Chung, San Mateo, CA (US)

Correspondence Address: Dergosits & Noah LLP, Suite 1450, Four Embarcadero Center, San Francisco, CA, 94111, US

(21) Appl. No.: 10/805,097

(22) Filed: Mar. 19, 2004

(51) Int. Cl. G06F 17/60

(52) U.S. Cl. 705/31

(57) ABSTRACT

An automatic international tax planning system is described. In a distributed client server computer network, a transaction analyzer and tax planning system is employed to define a transaction between a company in a first country and a company in a second country. The system first identifies the business entities within a multinational company and the tax paying status for the business entities with respect to an international transaction. The system next identifies any intercompany transactions that can be created to reduce taxes paid by the company for a transaction involving a second company in a receiving country. A user interface takes input in the form of data and parameters from a user, and provides a selection of possible strategies regarding the routing and/or structuring of the transaction. The user selects one or more strategies to evaluate and engages a tax calculation engine to calculate the tax cost associated with the selected strategy. Once an appropriate transaction strategy is selected, the tax costs are calculated and the transaction is validated with respect to the laws of the source and receiving countries. The system can also configured to automatically prepare and file or cause the filing of any applicable tax returns in the source country.

### FIELD OF THE INVENTION

The present invention relates generally to corporate tax planning, and more specifically, to an automated system for minimizing taxes for a multinational group of companies.

### BACKGROUND OF THE INVENTION

Cross-border commercial transactions can often be complicated affairs that involve many significant issues, such as regulatory requirements, currency exchanges, customs clearances, and international taxes. Of these, the international tax issue is an often very significant factor with respect to potential costs associated with a transaction. Clever tax planning with respect to overseas transactions can often yield significant savings. However, such planning is only possible if the parties involved are knowledgeable about the tax laws and practices of the countries involved in the transaction. Because each country or territory can have different tax laws and rates, the possible variation of tax exposure can vary widely depending on the transaction.

In general, the two main taxes associated with a cross-border transaction include a mainstream (corporation) tax and a withholding tax. The mainstream tax refers to a company's overall liability to corporation tax, which is a tax on the profits of companies and unincorporated bodies. A company's profits generally include all sources of income and also capital gains, such as any profit from the sale of a property or an investment. The withholding tax is tax on income imposed at the source, i.e., tax that is deducted from certain kinds of payments and remitted to the government of the paying country. Withholding taxes are widely used with respect to dividends, interest, royalties and similar payments. The rates of withholding tax are frequently reduced by tax treaties between countries.

Because of the lack of a universal tax scheme and tax harmonization among the countries of the world, bilateral tax relationships can vary greatly among virtually any combination of inter-country trade relationship. Different countries often have different tax treaties and trade concessions with each of the other countries, so that the cost of doing business may vary greatly, or even be illegal, depending upon the trading partner involved. For example, a U.S. company dealing in a transaction with a company in the UK may face very different tax costs than if it dealt with a company in Japan. In some cases, the least cost option may not be a direct transaction between the companies in the buying and selling countries, but rather an intermediate sale through a company in a third country. For example, because of preferential tax benefits granted to a country such as Switzerland, it may be cheaper, tax-wise, for a U.S. company to route the transaction through Switzerland before Japan.

In order to determine the potential tax liability of a cross-border transaction, companies are presently required to contact local specialists, such as tax attorneys or accountants. This requires a great deal of research and initiative on the part of the company and can increase the costs of the transactions by a significant amount, as well as lead to significant delays in receiving a recommendation. Although some of the large multinational accounting firms, such as KPMG and PriceWaterhouseCoopers can provide some services with regard to international tax planning, the costs for such a service can be quite high, and the recommendations may not be tailored to the exact needs of the client. Furthermore, the local or traditional big accounting firms may not have knowledge of the various routing schemes that may be available to minimize the international taxes associated with a transaction. In this case, the client may be forced to figure out for himself, what the lowest cost transaction may be based on the information provided.

What is needed, therefore, is an automated international tax planning system that automatically calculates the tax costs for a particular cross-border commercial transaction.

What is further needed is an international tax planning system that minimizes the total tax cost of a particular international transaction.

### SUMMARY OF THE INVENTION

An automated system for minimizing tax costs associated with international commercial transactions is described. In one embodiment of the present invention, a distributed client server computer network includes a strategy/transaction analyzer and tax calculation system. The system first identifies the business entities within a multinational company and the tax paying status for the business entities with respect to an international transaction. The system next identifies any intercompany transactions that can be created to reduce taxes paid by the company for a transaction involving a second company in a receiving country.

A user interface takes input in the form of data and parameters from a user, and provides a selection of possible strategies regarding the routing and/or structuring of the transaction. The user selects one or more strategies to evaluate and engages a tax calculation engine to calculate the tax cost associated with the selected strategy. Once an appropriate transaction strategy is selected, the tax costs are calculated and the transaction is validated with respect to the laws of the source and receiving countries. The system can also configured to automatically prepare and file or cause the filing of any applicable tax returns in the source country.

Other objects, features, and advantages of the present invention will be apparent from the accompanying drawings and from the detailed description that follows below.

### BRIEF DESCRIPTION OF THE DRAWINGS

The present invention is illustrated by way of example and not limitation in the figures of the accompanying drawings, in which like references indicate similar elements, and in which:

FIG. 1 illustrates a network for implementing an automated international tax planning system, according to one embodiment of the present invention;

FIG. 2 is a flow chart that illustrates the main process steps of the automated international tax planning system, according to a method of the present invention;

FIG. 3 is a block diagram that illustrates the main functional components of the automated international tax planning system, according to an embodiment of the present invention;

FIG. 4 is a block diagram that illustrates in greater detail the processing blocks and process flows for the tax planning system of FIG. 3;

FIG. 5 is a block diagram that illustrates the operation of the worldwide tax calculator according to an exemplary scenario for a representative cross-border transaction;

FIG. 6 is a flowchart that illustrates the steps executed by the transaction analyzer unit, according to one embodiment of the present invention;

FIG. 7 is a flowchart that illustrates the steps undertaken by a user of the international tax planning process, according to one embodiment of the present invention;

FIG. 8A illustrates a screen display for defining a cross-border transaction, according to one embodiment of the present invention;

FIG. 8B illustrates a screen display of a tax information report providing details of the computation of the after tax cash component for the embodiment illustrated in FIG. 8A;

FIG. 9 illustrates a screen display for the transaction analyzer component of the international tax planning process, according to one embodiment of the present invention; and

FIG. 10 illustrates a screen display for the simulator component of the international tax planning process, according to one embodiment of the present invention.

### DETAILED DESCRIPTION OF THE PREFERRED EMBODIMENT

An automated international tax planning system for determining tax costs associated with cross-border commercial transactions is described. In the following description, for purposes of explanation, numerous specific details are set forth in order to provide a thorough understanding of the present invention. It will be evident, however, to one of ordinary skill in the art, that the present invention may be practiced without these specific details. In other instances, well-known structures and devices are shown in block diagram form to facilitate explanation. The description of preferred embodiments is not intended to limit the scope of the claims appended hereto.

Aspects of the present invention may be implemented on one or more computers executing software instructions. According to one embodiment of the present invention, server and client computer systems transmit and receive data over a computer network or a fiber or copper-based telecommunications network. The steps of accessing, downloading, and manipulating the data, as well as other aspects of the present invention are implemented by central processing units (CPU) in the server and client computers executing sequences of instructions stored in a memory. The memory may be a random access memory (RAM), read-only memory (ROM), a persistent store, such as a mass storage device, or any combination of these devices. Execution of the sequences of instructions causes the CPU to perform steps according to embodiments of the present invention.

The instructions may be loaded into the memory of the server or client computers from a storage device or from one or more other computer systems over a network connection. For example, a client computer may transmit a sequence of instructions to the server computer in response to a message transmitted to the client over a network by the server. As the server receives the instructions over the network connection, it stores the instructions in memory. The server may store the instructions for later execution, or it may execute the instructions as they arrive over the network connection. In some cases, the downloaded instructions may be directly supported by the CPU. In other cases, the instructions may not be directly executable by the CPU, and may instead be executed by an interpreter that interprets the instructions. In other embodiments, hardwired circuitry may be used in place of, or in combination with, software instructions to implement the present invention. Thus, the present invention is not limited to any specific combination of hardware circuitry and software, nor to any particular source for the instructions executed by the server or client computers. In some instances, the client and server functionality may be implemented on a single computer platform.

Aspects of the present invention can be used in a distributed electronic commerce application that includes a client/server network system that links one or more server computers to one or more client computers, as well as server computers to other server computers and client computers to other client computers. The client and server computers may be implemented as desktop personal computers, workstation computers, mobile computers, portable computing devices, personal digital assistant (PDA) devices, or any other similar type of computing device.

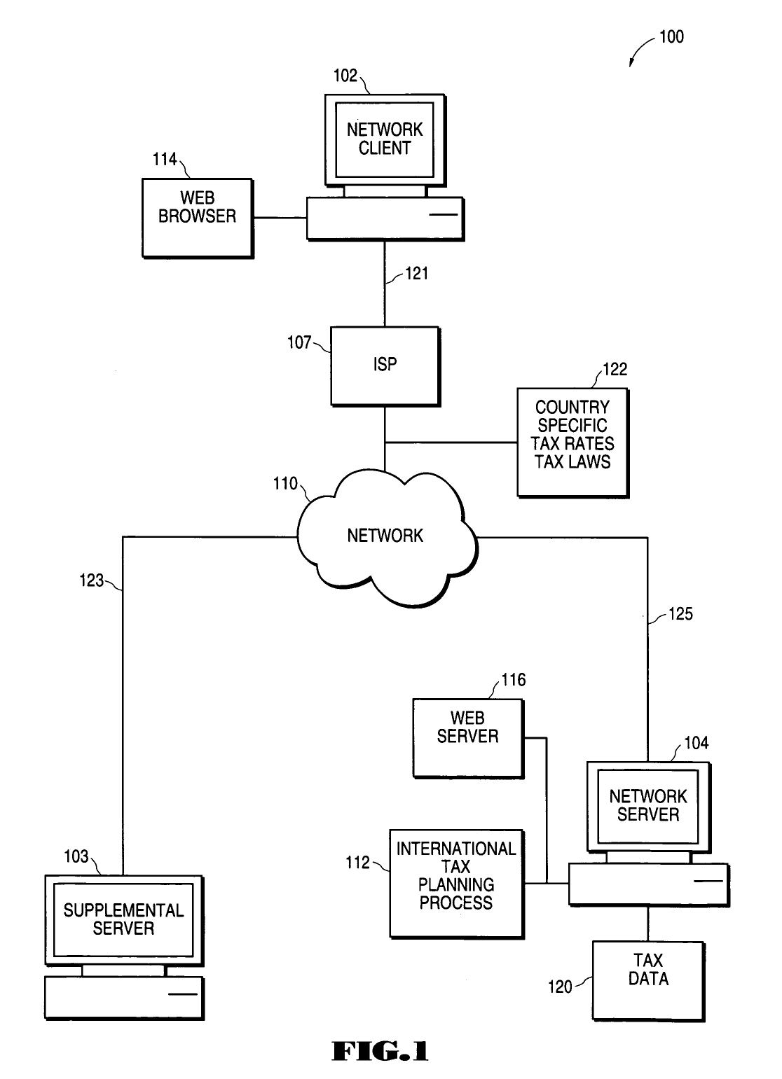

FIG. 1 illustrates an exemplary network system that includes distributed client/server computers that execute an international tax planning process for defining a cross-border transaction and determining the tax costs of the transaction. In the network embodiment illustrated in FIG. 1, the server computer 104 executes an international tax planning process 112. This process includes several components that determine a company's tax liability, find tax rates for countries in which the company may effect commercial transactions, and determine different tax strategies to minimize the tax cost for these transactions.

The international tax planning process 112 may be implemented as either a server-side process (remote) or a client-side (local) process. As a client-side process, the program is loaded and executed as a resident application program on a client computer, e.g., network client 102 in FIG. 1. As a server-side process, the program is executed in a traditional client-server distributed network, as illustrated in FIG. 1. The program resides on a server computer 104 and is accessed by an interface executed on the client computer 102.

For a network embodiment in which the client and server computers communicate over the World Wide Web portion of the Internet, the client computer 102 typically accesses the network through an Internet Service Provider (ISP) 107 and executes a web browser program 114 to display web content through web pages. In one embodiment, the web browser program is implemented using Microsoft® Internet Explorer™ browser software, but other similar web browsers may also be used. Network 110 couples the client computer 102 to server computer 104, which executes a web server process 116 that serves web content in the form of web pages to the client computer. In addition, the system 100 may also include other networked servers, such as supplemental server 103.

The system 100 illustrated in FIG. 1 calculates the tax costs for international transactions. These transactions rely on tax and regulatory data that is country-specific and often available only through specific sources, such as government or corporate entities. An important component of system 100 is the database or databases of the country-specific tax rates, laws, regulations, and other tax-related data 122. This data may be available through many different sources, such as tax authorities or finance ministries within a specific country, local or global accounting or commercial law firms, or other international tax databases or service providers. Such tax data, at least for certain countries, may also be loaded as resident data on the server computer 104. Additionally, this data may be provided by one or more supplemental servers 103 coupled to network 110. In general, the relevant tax data may be available from many different sources accessible to server 104 over network 110. The tax calculation process 112 includes a data mining process that identifies, locates, and downloads the appropriate tax data for use in the tax calculation routine.

An international transaction is a commercial transaction that involves at least two commercial entities (companies) in two different countries. The buying and selling of a product or service by the two companies usually has tax implications for both companies depending on the tax laws of the countries, the status of the companies, and any applicable treaties between the two countries. Although a transaction may be directly executed between the two companies subject to the tax structure of the two countries, it may be sometimes advantageous to structure the transaction through one or more intermediary countries using subsidiary companies or third-party companies to take advantage of favorable tax rates or laws in the intermediary country. For example a company in Korea selling a product to a company in the U.S. may find it advantageous to sell the product through a holding company in Germany due to more favorable tax rates between Germany and the U.S. as opposed to Korea and the U.S. Besides the physical routing of a transaction among countries in a transaction, other factors often impact the tax cost, such as use of capital versus debt to fund the transaction, partial trades or offsets as consideration, and many other factors.

In general, the international tax planning process 112 embodies an international tax planning tool that helps a user to minimize taxes in the source and destination countries for a transaction. The process 112 includes an “ideas” or strategy subprocess that provides various different strategies that can be used to structure a particular international transaction, and a tax commentary section that provides guidance as to the tax rates and laws for the relevant countries. The process 112 also includes a simulation section that calculates the tax costs if additional countries are inserted into the transaction as intermediary countries. For this a database or databases of world-wide tax rates is accessed. The international tax planning process 112 thus comprises a suite of programs that access and synthesize tax data, provide tax and transaction strategy information, and execute simulated transactions based on user input to minimize the taxes associated with an international transaction.

Traditionally, tax data providers show country-to-country withholding tax information to aid tax practitioners in minimizing overall taxes of a transaction. However, the withholding tax alone is often insufficient in determining the overall tax cost for most international transactions. This is because the overall tax cost involves calculating tax consequences in both the paying and receiving tax jurisdictions, taking into account many possible different factors. These factors include the deductibility of the payment in the paying country, the withholding tax on the payment in the paying country, any credits and/or refunds related to the payment in the paying country, the taxable income inclusion in the receiving country, corporate tax rates in the receiving country, tax credits given in the receiving country, and other possible such factors. These factors are accounted for in the subprocesses comprising the international tax planning process 112. For purposes of the following discussion, it should be noted that the term “paying country” refers to the country in which the company that providing the goods or services and paying the tax is located, and the term “receiving country” refers to the country in which the company receiving the goods or services is located.

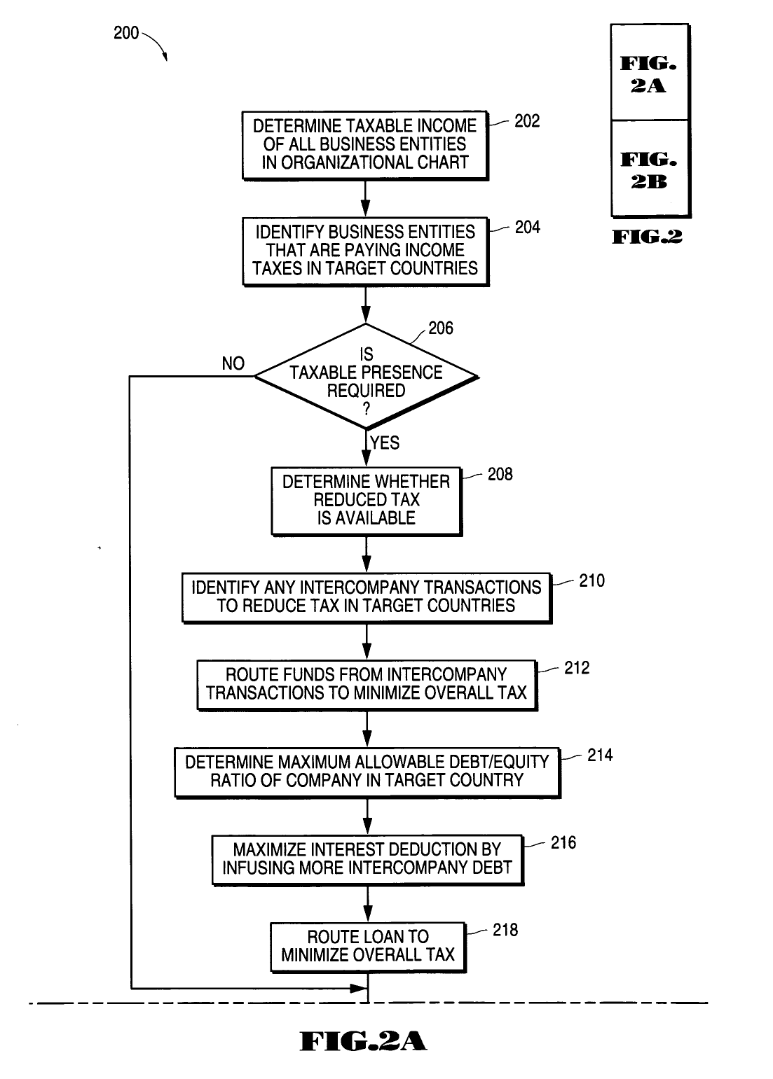

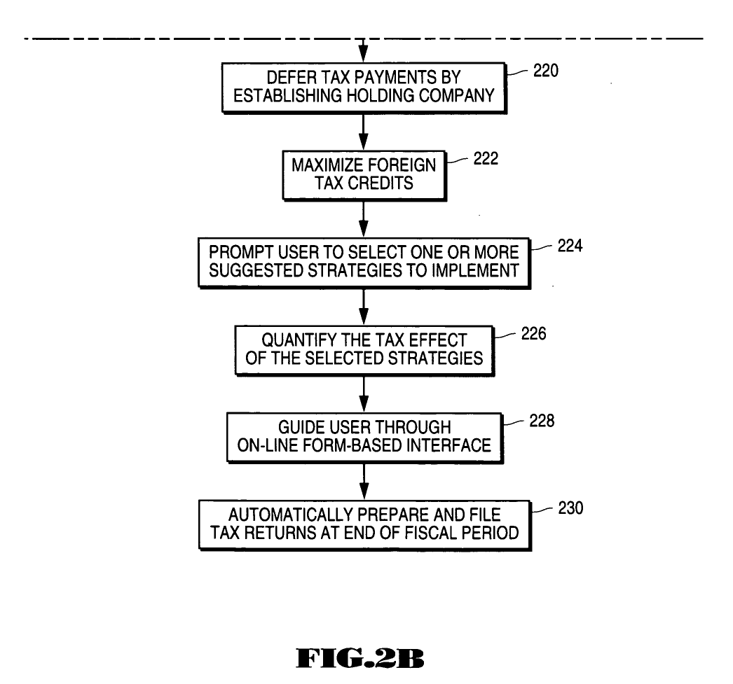

FIG. 2 is a flowchart that illustrates the basic processes executed by the international tax planning process 112 of FIG. 1, according to one embodiment of the present invention. As an overview, the tax calculation process determines the tax status of all the business entities in the organizational chart of the company, that is, the parent company and its subsidiaries. It then suggests tax planning strategies, quantifies the tax effect of the suggested strategies, suggests implementation steps, files any necessary forms, and then files the tax returns in all taxing jurisdictions. In an automated embodiment of the invention, all of the tax-related tasks are done end-to-end and automatically through computer-implemented processes. Any operator intervention that is required typically involves only the initial execution of the program and the selection of operating parameters and selected strategies.

The process 200 first determines the taxable income of all of the business entities in its organization chart, step 202, and identifies business entities that are paying income taxes in the target country or countries, step 204. The target country is the country in which the trading partner company is located, or an intermediary country if one is used.

In step 206, the process determines whether a taxable presence is required in the target country. A taxable presence is a corporate presence or transaction that exposes the company to any tax liability (e.g., sales, property, franchise tax, etc.). If a taxable presence is not required, the system will skip to step 220, as the tax in the target country is effectively minimized already. If, however, a taxable presence is required, the process next determines whether a reduced tax rate is possible, step 208. Using appropriate tax rate and regulatory data available for the target country, the process determines and suggests whether a taxable presence can be avoided in the target countries (i.e., no tax) or whether special tax rates can be obtained by either special tax regimes based on activities in the country or by setting up special entities. The goal of these process steps is to see if tax can be avoided altogether or if a lower tax rate can be obtained.

If a taxable presence is needed and reduced tax rates are not available, then the process will attempt to find a way to reduce the taxable income in the target countries by creating or modifying intercompany transactions, step 210. Intercompany transactions are transactions between the affiliates in the organization chart of the company. Such transactions include loans (which generate interest income and deductions), licenses (which generate royalty income and deductions), sales, and investments (which generate dividend income). The process identifies any intercompany transactions that can help to reduce tax costs in the target countries, step 210. The process will further suggest how to route the funds from the intercompany transaction to minimize the overall tax cost, step 212. For example, instead of having a U.S. entity lend money to a Japanese entity directly, it may be cheaper, tax-wise to use a Hungarian entity as a conduit.

To further reduce taxable income in the target countries, the process also performs certain steps to maximize interest deductions. As shown in step 214, the process determines the maximum allowable debt/equity ratio of the company in the target countries. This maximum amount is typically based on the tax laws of each country. In some cases, the process may determine that it may be advantageous to infuse more intercompany debt to maximize interest deduction in the target countries, step 216. The process then suggests how to route the loan through one or more intermediary countries to minimize the overall tax cost, step 218.

The process next determines the tax status of the parent company to see if establishing a holding company and deferring paying taxes in the parent country is beneficial, step 220. If so, the process will recommend to user the option of establishing a holding company, and will provide a selection of possible countries. If income cannot be deferred, the process will determine how to maximize foreign tax credits in the parent company to further reduce tax, step 222.

In one embodiment of the process 200 illustrated in FIG. 2, a user interface is provided to facilitate the input and output of information between the user and the system. When the user wants to implement any of the above strategies, a semi-automated work process engine will guide the user through the implementation process. Necessary implementation forms will be suggested and in some cases filled out automatically by the process. Through the user interface process, the system prompts the user to select one or more suggested strategies for implementation or evaluation (simulation). One or more transaction analyzer or calculation units within the system will quantify the tax effect of the selected strategies, step 226. The user will be guided through the selection and calculation processes by an on-line graphical user interface (typically web-based), step 228. Upon completion of the strategy selection process and calculation of applicable taxes, the system will automatically prepare the relevant forms and cause their filing at the end of any appropriate fiscal period, step 230.

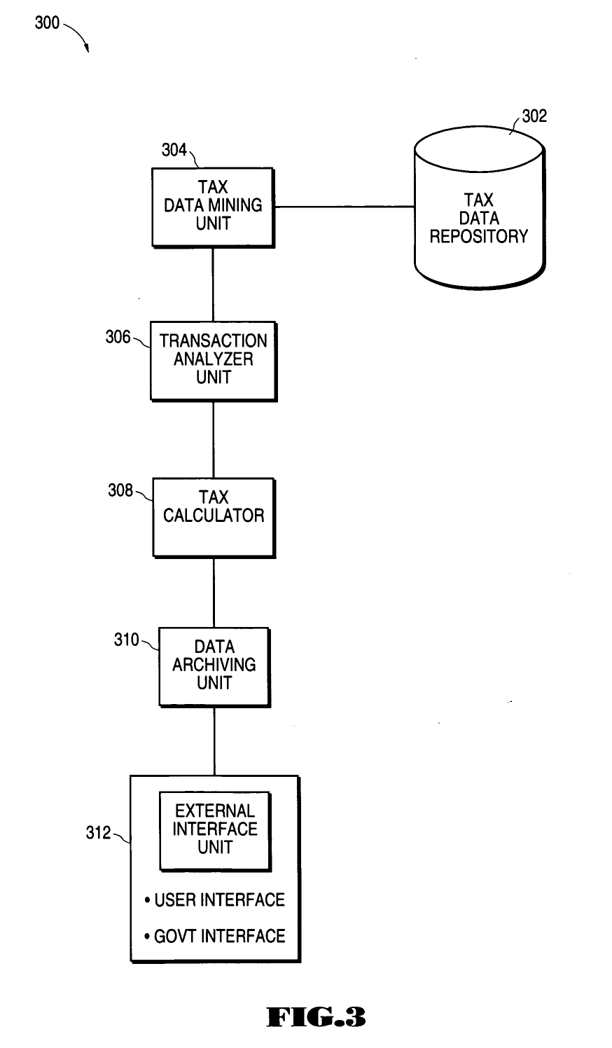

FIG. 3 is a block diagram illustrating the main functional components within the international tax planning process 112, according to one embodiment of the present invention. System 300 includes a tax data mining unit 304 that accesses one or more tax data repositories 302 that store the relevant tax codes, rates, laws, etc. for each of the target countries. Typically, such data is stored in databases within the banks, financial institutions, government agencies, or companies within each target country. The different corporate organization, transaction, and finance routing strategies that are available to be selected by a user are evaluated by a transaction analyzer unit 306. Based on the selected strategies (suggested transactions), the tax costs are calculated by a tax calculator 308. A data archive unit 310 stores the relevant data and tax costs for each of the selected strategies for purposes of implementation or comparison.

The system 300 also includes an external interface unit 312. This unit comprises an electronic interface to various different corporate and government entities, such as corporate clients, tax advisors, tax authorities in each country, and so on. Through this interface, the international tax planning process 112 automates the international tax planning process, implementation and tax and legal compliance (filing forms etc).

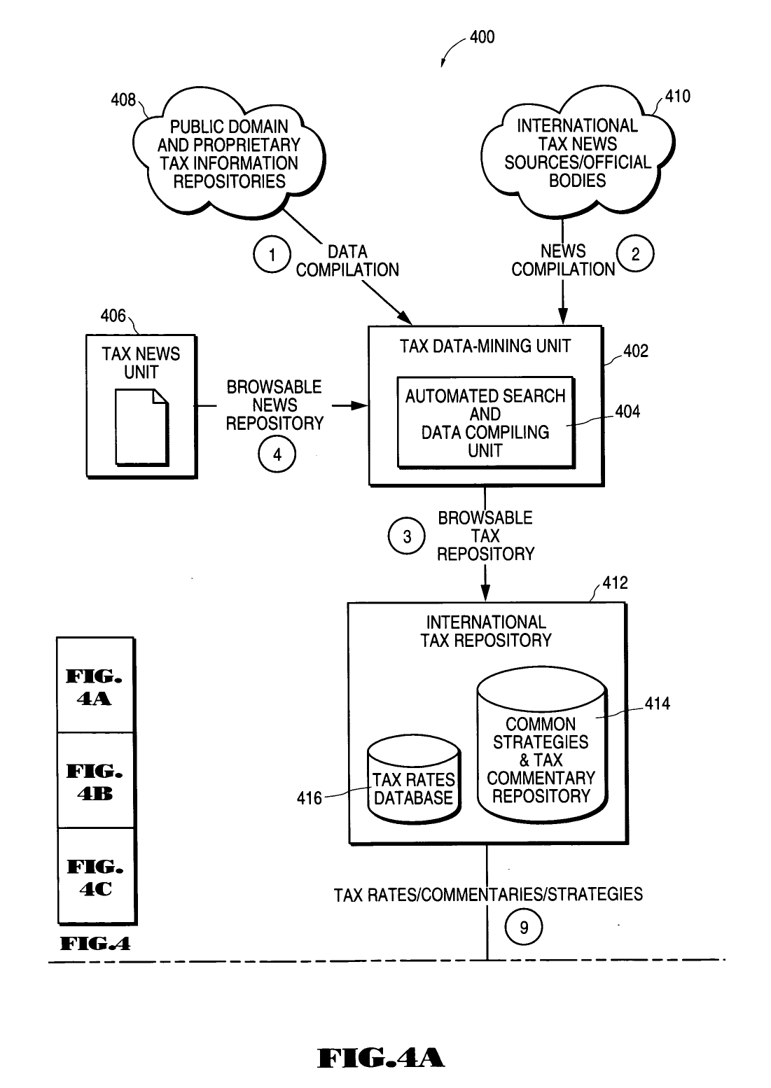

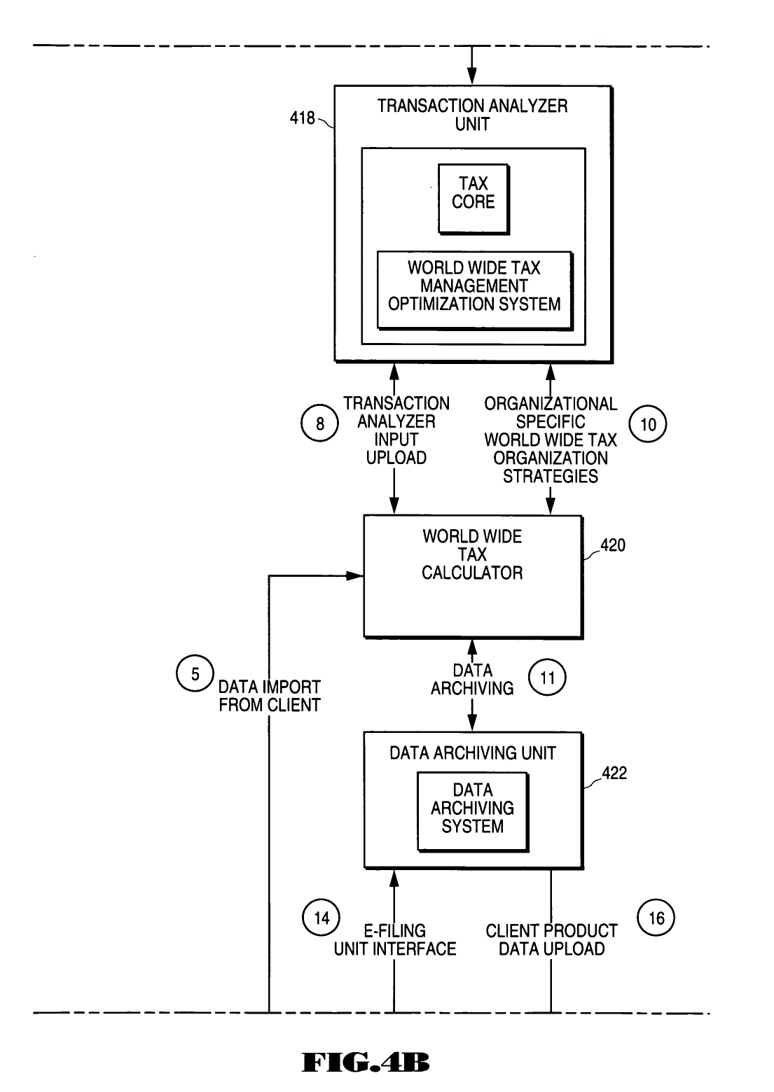

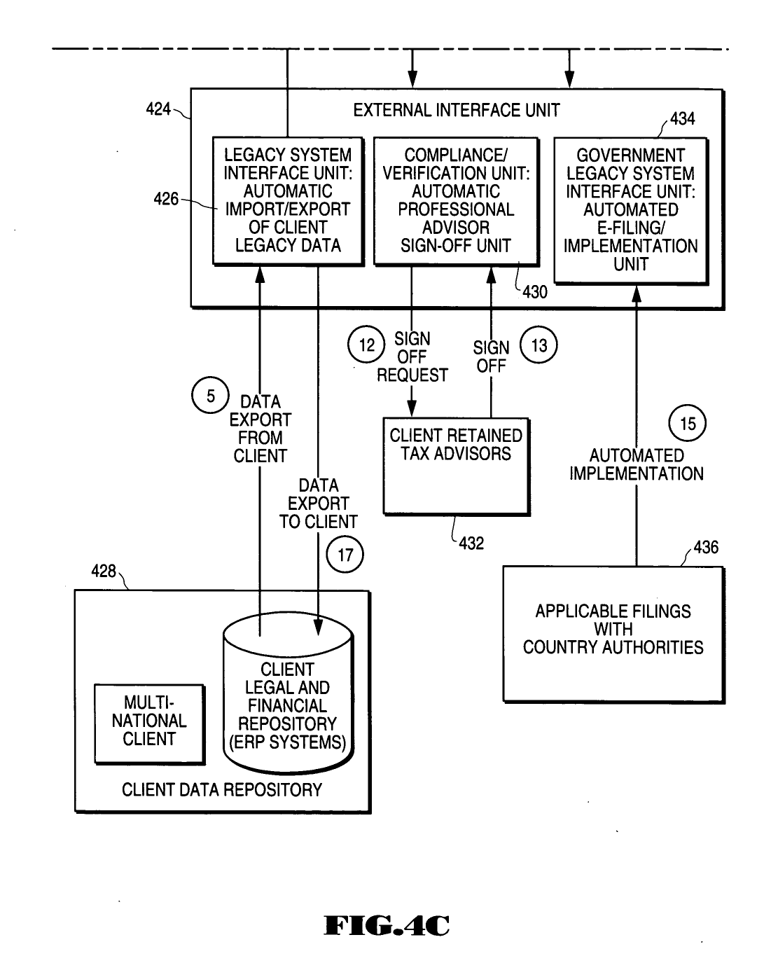

FIG. 4 is a block diagram that illustrates in greater detail the processing blocks and process flows for the tax planning system of FIG. 3. The system 400 includes as a front-end, a tax data mining unit 402, which includes an automated search and data compiling unit 404. This data compiling unit searches and finds all relevant data related to tax codes and rates. The sources searched by the data mining unit 402 include international tax news sources 410, public domain and proprietary tax information repositories 408 and tax news sources 406. The tax news sources 406 may be an internal unit or database that periodically compiles and stores tax industry news from various news or industry sources. The tax data mining unit 402 executes data compilation 1, news compilation 2, and browsable news repository 4 download processes to obtain the relevant tax information.

The tax data mining unit 402 also includes an interface 3 to an international tax repository 412 that includes a database for storing common tax strategies and commentary regarding the strategies 414, and a database of tax rates 416. The data mined from the mining unit 402 is stored in the databases 414 and 416 in international tax repository 412. This repository can be stored either locally on the server computer that executes the tax calculation process, or it can be stored remotely on a separate networked data server.

The tax rates, strategies, and commentaries stored within the tax repository 412 are compiled and provided to the user in the form of selectable strategies that are suggested as possible ways to reduce tax costs. Through interface 9, these data items are provided to a transaction analyzer unit 418. This analyzer unit includes a tax core and world-wide tax management optimization system. The transaction analyzer unit 418 takes as input, data from a world-wide tax calculator 420. The tax calculator 420 includes information regarding the organizational chart of the company, the business entity legal status, its financial data, and other information. This data is used by the organization strategy interface 10 and the transaction analyzer input upload interface 8 to help the tax management optimization system within transaction analyzer unit 418 determine the best tax strategy based on the company organization.

The world-wide tax calculator 420 is coupled through a data archiving interface 11 to a data archiving unit 422. This unit is coupled to an external interface unit 424 through an e-filing unit interface 14 and a client project data upload interface 16. The external interface unit 424 is also coupled to the world-wide tax calculator 420 through a data import interface 5. The external interface unit 424 includes a legacy system interface unit 426, which interfaces to a client company data repository 428. This repository is essentially a database for legal and financial data (ERP Systems) for the client company. Typically, the client is a multinational company with legal and financial information regarding operations, vendors, customers, and so on, in various different countries. The client data repository interfaces with the legacy system interface unit through interface 5 for data exports from the client company, and interface 17 for data exports to the client company.

The external interface unit 424 also includes a compliance verification unit 430. The compliance verification unit 430 includes a process that provides for automatic professional advisor verification or approval (“sign off”) of the selected tax reduction or fiscal routing strategies. This unit interfaces to tax advisors 432 retained by the client through interfaces 12 and 13. The unit transmits information regarding the strategies and/or transactions to the tax advisors 432 along with a sign off request over interface 12. Upon approval, all of the tax advisors transmit back a sign off message to the compliance verification unit 430.

A government legacy system interface unit 436 is also included within external interface unit 424. This unit is coupled to the computer systems of various country tax or finance authorities to automatically file, through interface 15, the applicable taxes or fees associated with the commercial transaction, based on the selected strategy or strategies.

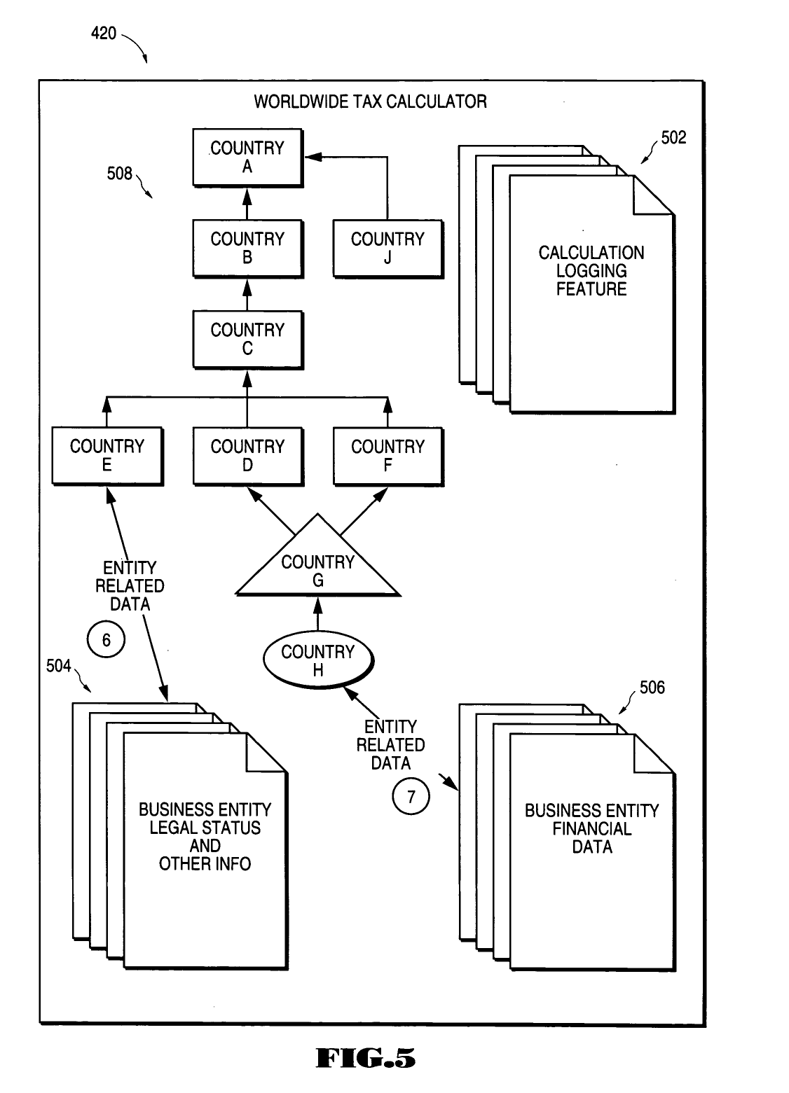

FIG. 5 is a block diagram that illustrates the operation of the worldwide tax calculator 420 of FIG. 4, according to an exemplary scenario for a representative cross-border transaction. For the illustrative transaction 508 shown in FIG. 5, a company in Country H is transacting with a company in Country A to either buy or sell goods and/or services. It is assumed that a direct transaction between the companies in country A and H will result in a high, if not the maximum, tax cost due to corporate and withholding taxes, and other associated transfer costs. The business entity and financial data 506 for the company in country H is accessed through interface 7. Using the strategy information provided by the transaction analyzer unit 418, it might be determined that the optimum transaction between the two companies, tax-wise, may be to route the transaction through a number of intermediary countries B-G. For the example, the money may first be routed from country H to country G, and then split to countries D and F. Also, a holding company may be established in country E. For this company, business entity and financial data 504 is accessed through interface 6. Payments from countries E, D, and F are then routed through countries B and C to country A. A calculation logging feature 502 records and stores the transaction at each stage of the transfer so that costs through the entire route can be monitored.

The concept of international transactions for multinational corporations can be highly complex given the different corporate structures, transaction types, and tax laws in the different countries. Thus, calculating the worldwide tax for a transaction can be very time consuming, especially when one country would characterize the type of an entity differently than another country with regard to their respective tax laws. For example, assume a U.S. company owns a Japanese subsidiary which in turn owns a Chinese subsidiary. For tax purposes, assume further that the U.S. treats the Chinese subsidiary as a branch of the Japanese subsidiary (meaning the branch is treated as part of Japanese subsidiary for U.S. tax purposes), while Japan treats the subsidiary as a corporation (a separate taxable entity for Japanese tax purposes). When calculating the U.S. tax, one must ignore the Chinese subsidiary as a separate taxable entity, while for Japanese tax calculation purpose, this entity is respected as a separate taxable entity. This asymmetry in tax characterization of entity is both confusing and burdensome in the absence of a system to capture this asymmetry, quantify the difference, and carry the values to the worldwide tax calculation.

The problem becomes even more complex when the user desires to quantify the impact of a transaction. For the same example, assume further that the Chinese subsidiary owns a subsidiary in Singapore that is treated as a branch for both Chinese and Japanese tax purposes, while it is considered a corporation for U.S. tax purposes. Assume also that the Singaporean subsidiary makes a distribution to the Chinese subsidiary. This payment may not be considered a “dividend” distribution as both Chinese and Japanese tax laws consider the Singaporean subsidiary as a branch and not a corporation. Accordingly, the tax calculation in China and Japan will be done based on this characterization of “branch remittance.” The U.S. however, considers this payment as a dividend distribution straight to the Japanese subsidiary as the U.S. tax law considers the Singaporean subsidiary as a separate corporation while ignoring the Chinese subsidiary. To properly calculate worldwide tax, therefore, one should view the income and tax of an entity from several different perspectives. In the example above, how the U.S. views the income and taxes of the Japanese subsidiary is different from how Japan views the income and taxes. This example illustrates how tremendously complex and time consuming, the tax calculation and planning process can be.

In one embodiment of the present invention, the tax planning system 112 includes an automated process using a tax calculation algorithm that first allocates payments and receipts among the parties, then starts the calculation from the lowest tier entity, stores relevant tax parameters separately from all relevant tax jurisdiction perspectives, then carries them up through the transaction chain. As a result of this algorithm, the system provides an automated worldwide tax calculation process that can be used to compare the effect of various transactions on a real time basis.

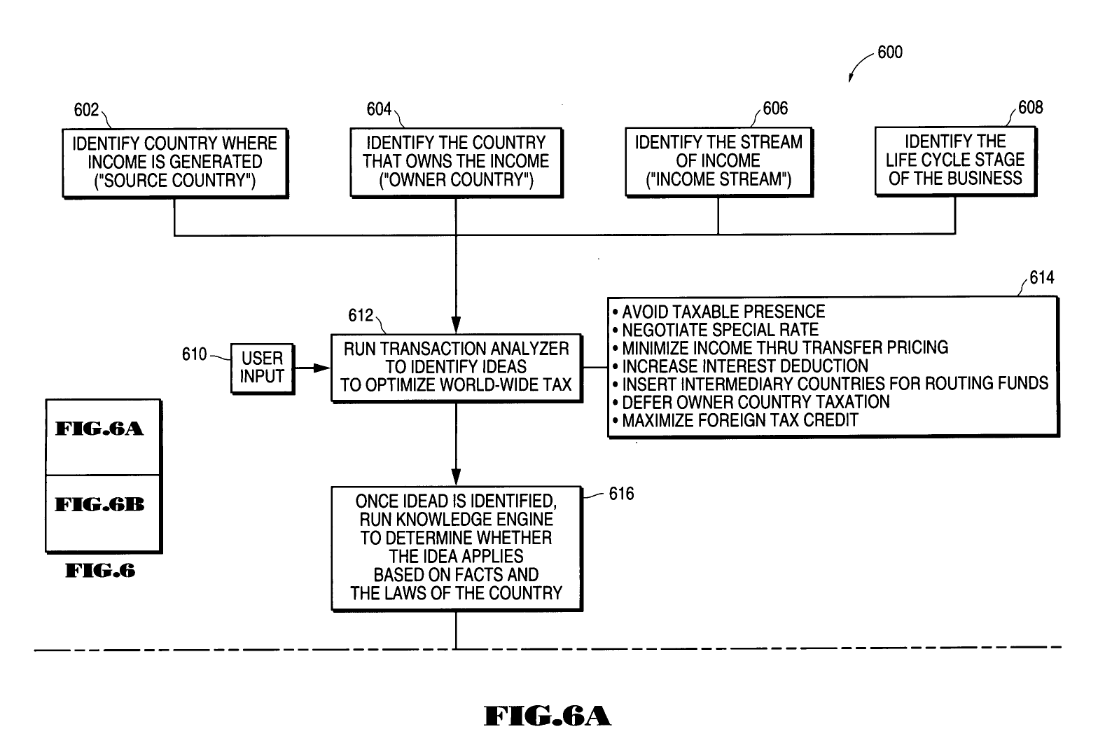

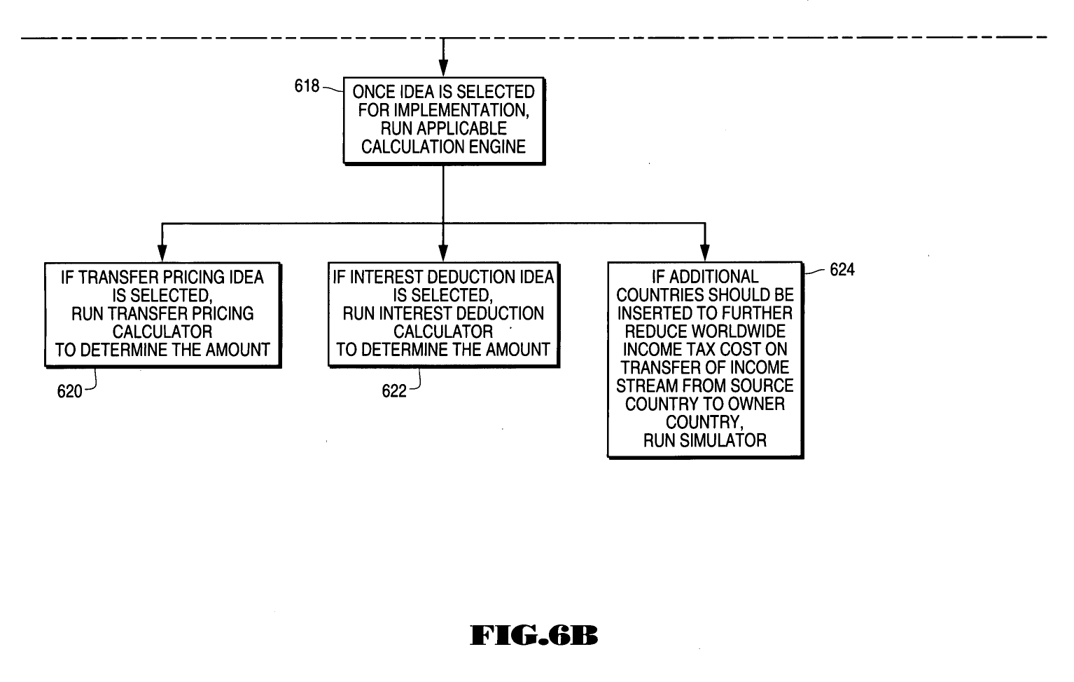

The comparison of the effect of various transactions is performed by a transaction analyzer unit or subprocess within the tax planning process 112. FIG. 6 is a flowchart that illustrates the steps executed by the transaction analyzer unit 418 of FIG. 4, according to one embodiment of the present invention. In step 602, the country where the income is generated is identified. This is referred to as the “source country”. In step 604, the country that owns the income is identified. This is typically the destination country for the transaction, and is referred to as the “owner country” or “receiving country”. The income stream is identified in step 606, and the lifecycle stage of the business is identified in step 608. Once these items are identified, the transaction analyzer is executed using this data along with user input 610. In step 612, the transaction analyzer identifies one or more strategies that act to optimize the world-wide tax costs compared to a direct transaction between the source and owner countries. The strategies may include a number of various ideas 614, such as avoiding a taxable presence, negotiating special rates, minimizing income through transfer pricing, increasing interest deductions, inserting intermediary countries for routing of funds, deferring owner country taxation, maximizing foreign tax credits, and other similar ideas or mechanisms. Steps 602 to 614 comprise the strategy browser component of the transaction analyzer unit.

Once an idea or strategy is identified, the knowledge engine is executed, step 616. This step determines whether the strategy is appropriate based on the facts of the transaction and the laws of the source, owner, and any intermediary countries. If the strategy is deemed to be appropriate and selected to be implemented, the calculation engine process is executed, step 618. If the transfer pricing idea is selected, the transfer pricing calculator is executed to determine the appropriate amount to charge for the suggested intercompany transaction step 620. If the interest deduction idea is selected, the interest deduction calculator is executed to determine the maximum interest that can be charged, step 622. If additional countries are to be inserted as intermediary countries, a simulator is executed to determine the countries to route the funds step 624. Steps 618 to 624 comprise the calculation component of the transaction analyzer unit. The costs calculated by the calculation component of the transaction analyzer unit are then provided to the worldwide tax calculator 420 illustrated in FIG. 4.

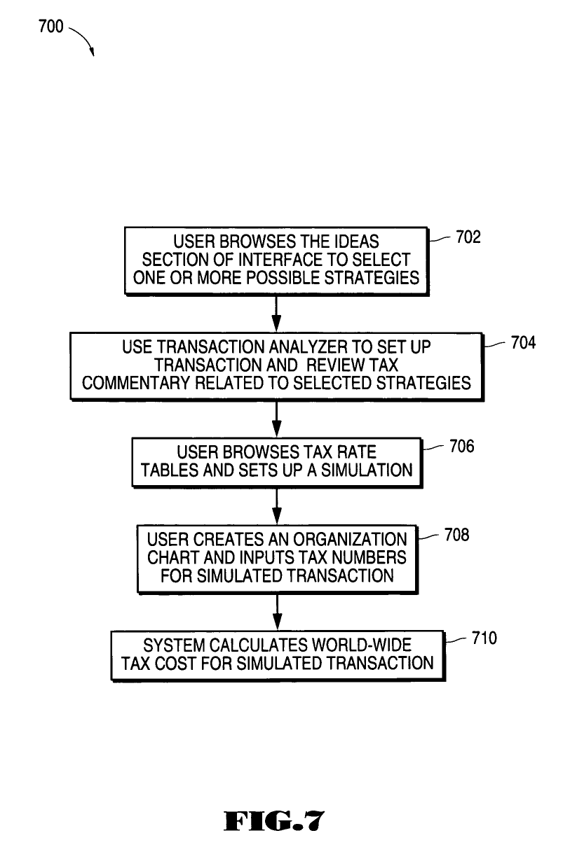

FIG. 7 is a flowchart that illustrates the steps undertaken by a user of the international tax planning process, according to one embodiment of the present invention. In step 702, the user browses the ideas section of the user interface to select one or more possible ideas or strategies to implement. The possible ideas/strategies can be the same or similar to those listed in box 614 of FIG. 6. In step 704, the transaction analyzer is used to define the overall transaction and review the tax commentary related to the selected strategy. The user then browses the tax rate tables to set up a simulation, step 706. The user then creates an organization chart and inputs the appropriate tax numbers for the simulated transaction. The system then calculates the world-wide tax cost for the simulated transaction. The process 700 can be executed any number of times for various different selected strategies or simulated transactions. This process can also be implemented to automatically iterate through a number of different strategies and simulations. Furthermore, although various inputs provided in section are provided directly by the user through one or more user interface access points, some or all of the required user data can be input automatically through automated input processes.

The international tax planning process 112 of FIG. 1 includes a graphical user interface component (element 312 in FIG. 3) that presents data to the user and allows the user to select various options and parameters to control the program. One view provided by the graphical user interface component is an enhanced tax database view. The enhanced tax database view displays all of the tax information, including the overall tax effect of a transaction, in a single table format with a detailed calculation report attached.

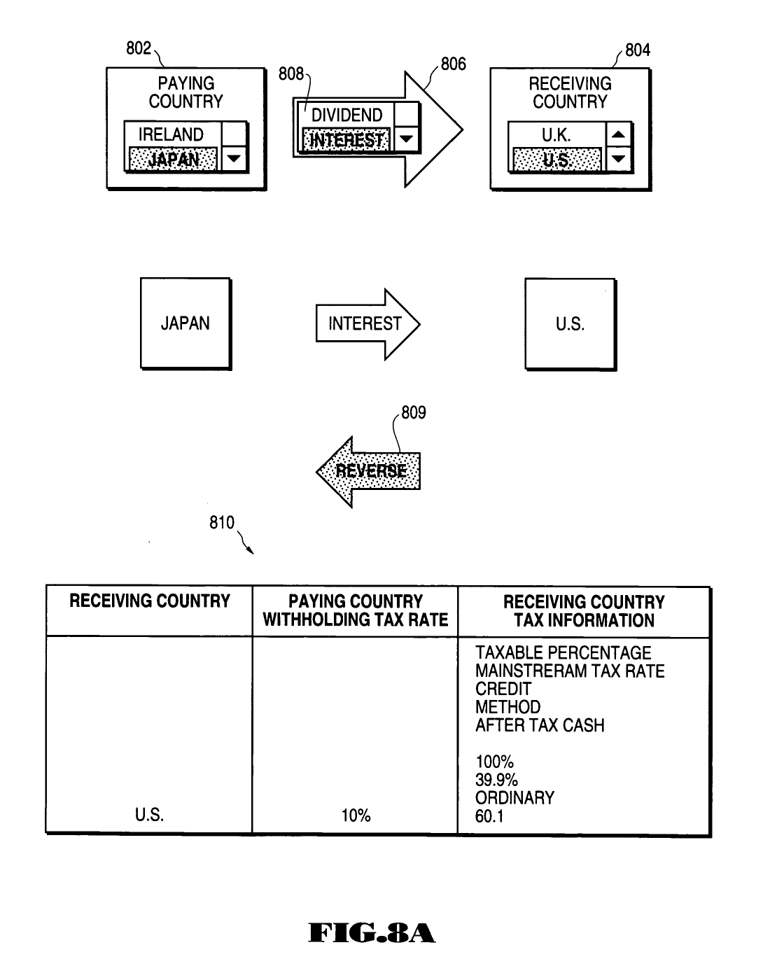

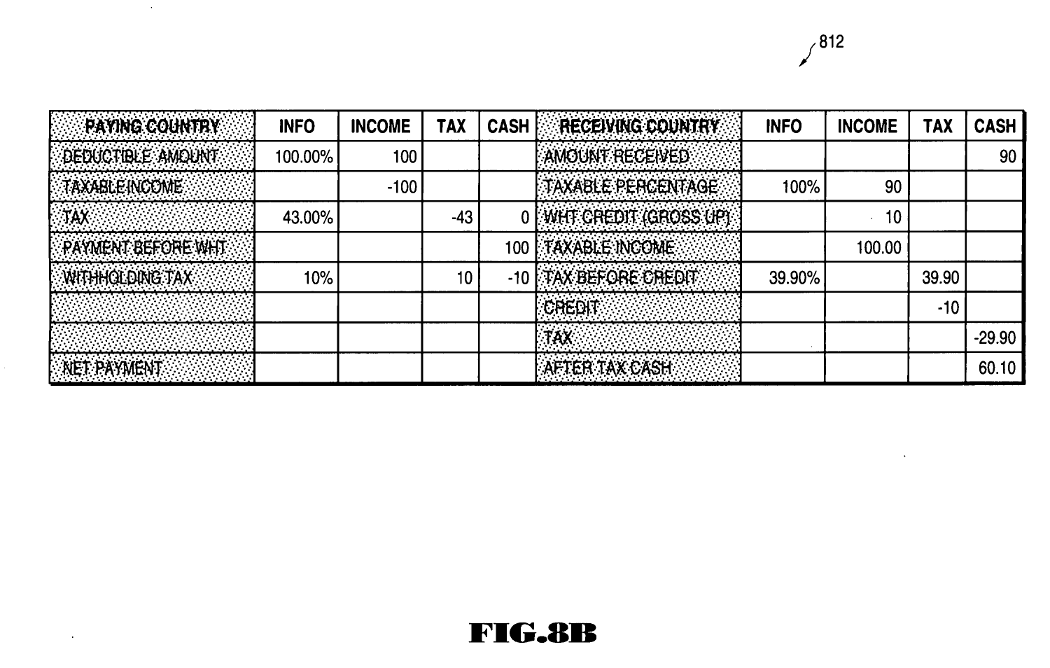

FIG. 8A illustrates a screen display for the defining a cross-border transaction, according to one embodiment of the present invention. The basic screen display provides two display boxes for specifying the paying country 802 and the receiving country 804. The user may type the name of the respective countries in the appropriate boxes or data entry areas, or if provided the user may select the name of the countries from dialog boxes provided as shown. A transaction stream arrow 806 defines the type of taxable transaction that is to be performed between the two countries. The possible streams are currently defined as interest, dividend, royalty or sales-based transactions. The type of stream (transaction) that is allowed depends upon the type of transaction, as well as the tax laws of the countries in involved in the transaction. A dialog box 808 may be provided to list the possible streams available between the countries for the user to select. For the example illustrated in FIG. 8A, the user has selected the paying country to be Japan and the receiving country to be the U.S., and the type of transaction to be an interest-based transaction between the two countries.

The enhanced tax database view interface illustrated in FIG. 8A also displays a table 810 that outlines the relevant tax information for the paying and receiving countries. For the example shown, the withholding tax rate for the paying country (Japan) is illustrated (10%), and the various tax rates for the receiving country (U.S.) are also shown. The interactive user interface illustrated in FIG. 8A allows the user to select various parameters (i.e., countries and transaction type) regarding the transaction. Once the parameters are selected, the tax calculator 308 is used to calculate the tax costs. The user interface generates a display screen that shows to the user the results of the tax calculation. A “reverse” command button 809 allows the user to view the tax costs when the paying and receiving countries are switched.

FIG. 8B illustrates a screen display of a report showing the details of the after tax cash calculation displayed in FIG. 8A. As shown in Table 812, the report breaks the transaction into components for each of the paying country and receiving country. The associated amounts and taxes for the transaction are illustrated in a logical and tabular format to allow the user to easily see the tax costs based on the selected transaction. The user can go back and change one or more of the parameters and execute another tax calculation to view the changes to the tax costs.

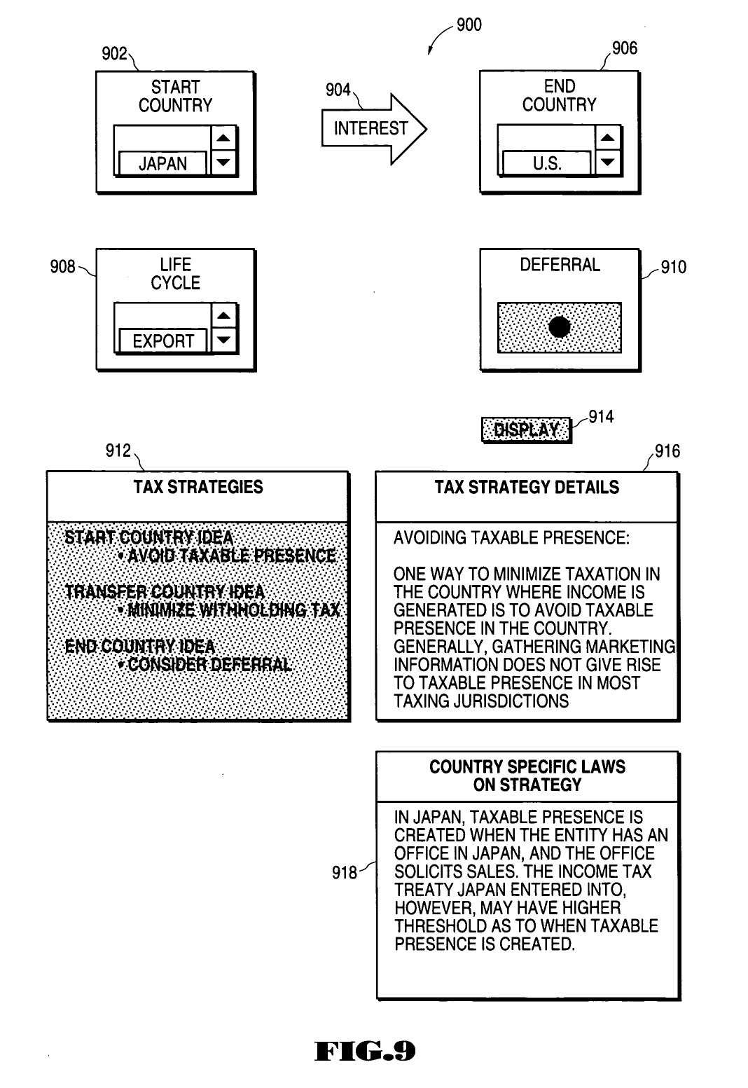

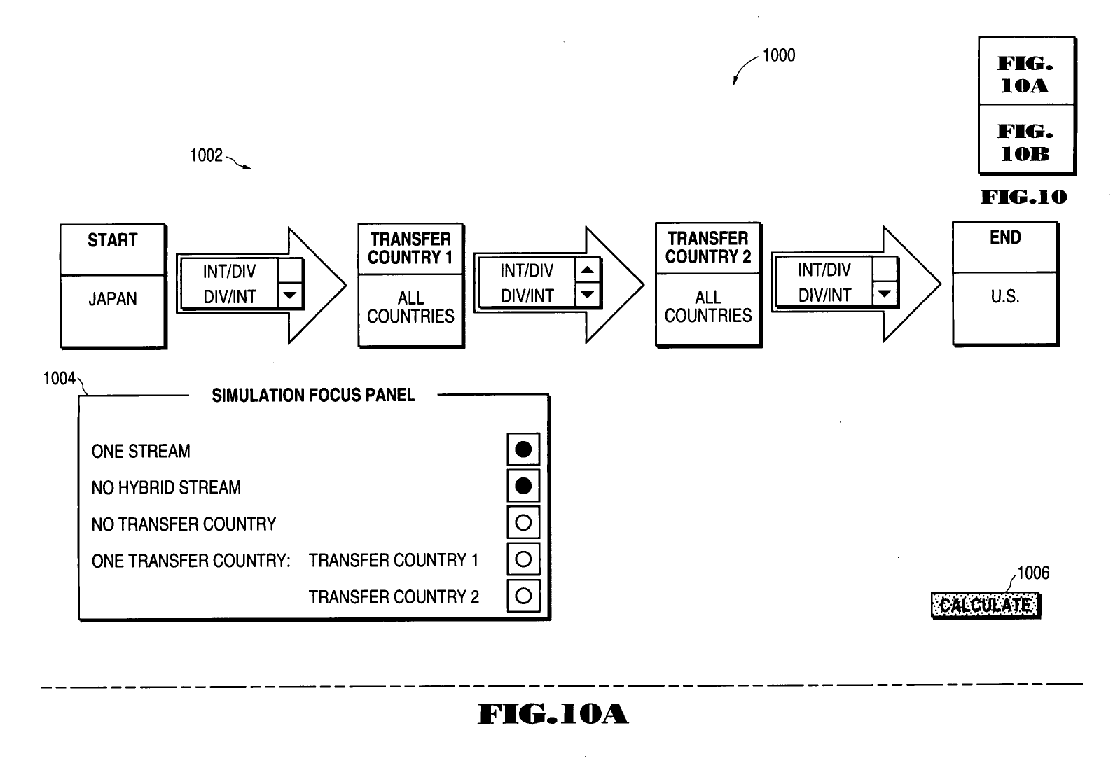

FIG. 9 illustrates an exemplary screen display for the transaction analyzer component of the international tax planning process, according to one embodiment of the present invention. The display screen 900 includes user input fields to specify the paying country 902, the receiving country 906, and the transaction stream 904. The countries can be selected from a list of all possible countries eligible to participate in the transaction. The transaction stream can be any of the following types of transactions: interest, dividend, royalty, or sales. Hybrid transactions are also possible, such as interest/dividend (interest for the paying country, dividend for the receiving country, or vice-versa), and royalty/sales (royalty for the paying country, sales for the receiving country, or vice versa).

With regard to hybrid transactions, traditional tax simulation or analysis programs typically assume that both the paying and receiving jurisdiction will characterize the payment stream in the same way. That is, both countries will treat the transaction as a dividend payment or an interest payment, and so on. In practice, however, it is possible that a characterization of a payment stream from the paying jurisdiction will differ from the characterization in the receiving country. For example, Japan may characterize a payment as deductible interest, while the U.S. will treat the payment as a dividend which carries foreign tax credits, creating tax savings opportunity. This type of transaction can be referred to as a “hybrid payments.” In one embodiment of the present invention, the tax planning process allows the user to define a transaction as a hybrid transaction that includes different treatment between the paying and receiving countries.

The transaction analyzer also allows the user to specify the life cycle 908 of the transaction. The life cycle characterizes the transaction as one of the following types: export, presence, acquisition, repatriation, and disposition. Also included is a dialog box 910 that allows the user to select whether the transaction is to be deferred or not. The user interface provides various display subwindows for alerting the user to various possible tax strategies 912. Related windows, such as 916 and 918 provide information on specific instructions for the recommended strategies, or tax laws related to the paying and/or receiving countries. To use the transaction user interface, the user specifies start country, end country, and payment stream, and also indicates what life cycle stage the business is in. The user next indicates whether there should be holding company underneath the end country so that income can be deferred from taxation in the end country (Deferral). When the user selects the “display” button, all the strategies will be shown. The user can select the desired strategy (e.g., avoiding taxable presence strategy blow). A detailed explanation of the strategy will then be displayed. The user can also see whether that strategy will be allowed in the country by looking at the “country specific laws on strategy” box.

Once the user has analyzed a particular strategy, the user can run a simulation to view the tax costs associated with the transaction. The user first picks the paying country, the receiving country, and a payment stream (e.g., interest, dividend, royalty, sales). User will then be presented with the filled out simulation screen showing all possible input combinations, including hybrid payments, and any possible transfer countries. The user can modify the input using a simulation focus panel and/or select/deselect countries, payment streams. The user clicks on the “calculate” button, which causes the simulation results to be displayed. The user can further tailor the simulation by using “Simulation Focus Panel.” The simulation results will be displayed based on total tax cost/benefits of the transaction as well as the total withholding tax costs of the transaction. The simulation focus panel allows the user to change various parameters related to the simulated transaction. These include the characterization of the transaction as a single stream or hybrid transaction, as well as the insertion of one or more intermediate transfer countries within the transaction.

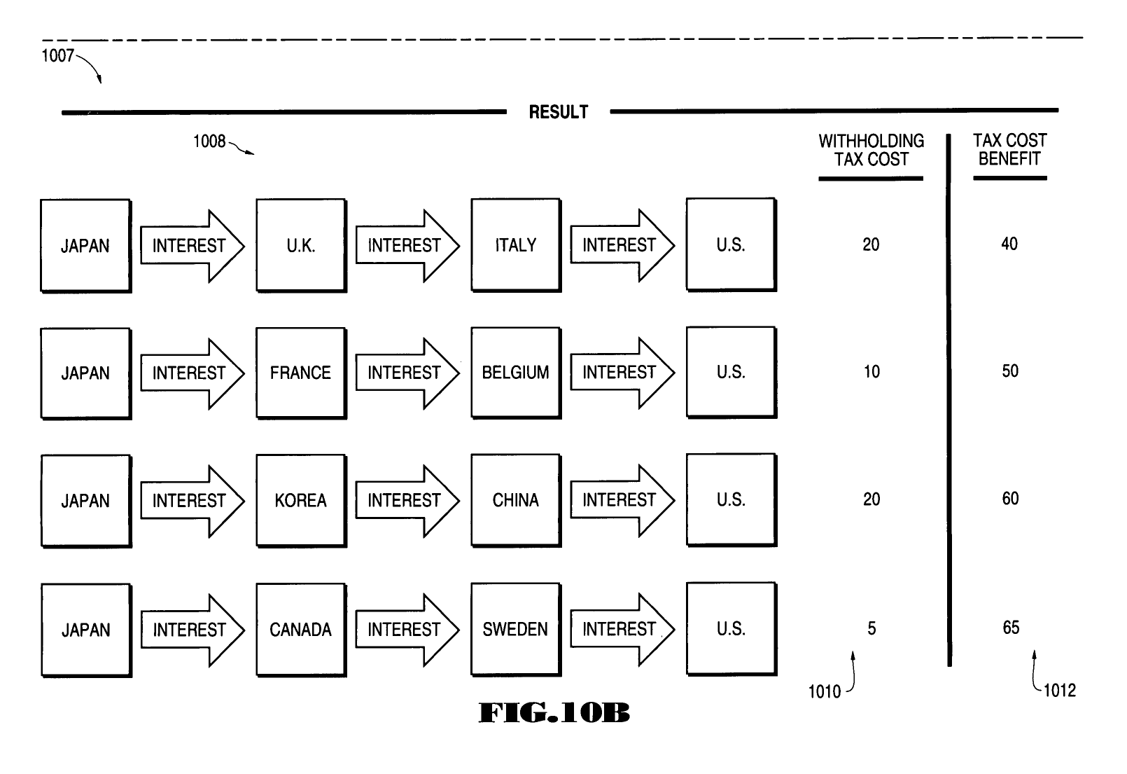

FIG. 10 illustrates a screen display for the simulator component of the international tax planning process, according to one embodiment of the present invention. The transaction display portion 1002 of screen display 1000 allows the user to specify the paying and receiving countries, and one or more transfer countries, as well as the type of transaction (stream) for each transaction in the line.

A simulation focus panel 1004 allows the user to modify or define the parameters of the transaction. If the user selects the “one stream” option, there will only be one non-hybrid stream applied throughout the transaction, e.g., only an interest or dividend payment throughout. This selection, therefore, will not allow hybrid stream, and further will not allow switching of the payment stream within the transaction. For example, if the transaction is a single stream type, there cannot be a paying country paying interest and the receiving county paying out a dividend to the next country in the line; in this case, the receiving country must pay out interest.

Selecting the “calculate” command button 1006 causes the process to display the tax costs results for the simulated transaction. The example illustrated in FIG. 10 shows the result screen area 1007 displaying four different transactions 1008. The variable within the four different transactions is the identity of the transfer countries. This yields different tax costs due to the different tax rates in the transfer countries. The withholding tax costs are shown in column 1010 and the relative tax cost benefit of the particular routing is shown in column 1012. Other different results could be obtained if the variable changed is the type of transaction versus the identity of the transfer country.

It should be noted that the organization and presentation of data and user input for the user interface screen displays illustrated in FIGS. 8A, 8B, 9, and 10 are exemplary only, and that various different designs of user interface display screens according to embodiments of the present invention are also possible.

In the foregoing, a system has been described for an international tax planning process for transnational commercial transactions. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

1. A computer-implemented method for minimizing the worldwide tax costs of a multinational group of companies, the method comprising:
determining taxable income and calculating taxes for each business entity within a multinational group of companies;
identifying intercompany transactions within the group that have the effect of reducing the tax costs in the countries in which receiving and paying companies are located;
calculating a tax cost of the transaction;
routing the transaction among different group entities to reduce the tax cost; and
calculating a worldwide tax cost as a result of implementing the identified intercompany transactions.

2. The method of claim 1 further comprising the method of suggesting one or more strategies to reduce the tax cost.

3. The method of claim 2 wherein the one or more suggested strategies includes one of obtaining a special tax rate by taking advantage of a local country tax holiday, establishing a special purpose entity, and avoiding a taxable presence.

4. The method of claim 2 wherein the one or more suggested strategies includes maximizing tax deductions by maximizing the intercompany price charged.

5. The method of claim 2 wherein the one or more suggested strategies includes maximizing interest deductions by infusing the maximum allowable intercompany debt.

6. The method of claim 2 wherein the one or more suggested strategies includes routing the intercompany transaction through several transfer countries to minimize withholding and mainstream taxes.

7. The method of claim 2 wherein one or more suggested strategies includes deferring tax payments in the receiving country by routing the income to holding company.

8. The method of claim 1 wherein one or more suggested strategies includes maximizing the foreign tax credits that can be claimed in the receiving country.

9. The method of claim 2 further comprising the steps of:
receiving user input regarding a selected strategy of the one or more suggested strategies; and
verifying the selected strategy in relation to laws of the country in which the paying company is located and the country in which the receiving company is located.

10. The method of claim 1 further comprising the step of automatically preparing and causing the filing of any applicable tax return documents for the company in the country in which the company is located.

11. A method of determining tax costs associated with an international transaction comprising the steps of:
receiving a user specified payment stream from the paying company located in a source country and a receiving company located in a receiving country;
retrieving tax data for the paying company and the receiving company;
providing one or more suggested transactions between the paying company and the receiving company for the routing of goods or services between the paying company and the receiving company;
calculating the cost of the transaction; and
calculating the impact on worldwide taxes as a result of implementing the recommended transactions.

12. The method of claim 11 wherein the tax data comprises all tax rates needed to determine the after tax cash in the receiving country including mainstream and withholding tax rates for the source country and the receiving country.

13. The method of claim 11 wherein the tax data comprises country-specific tax rates and tax laws.

14. The method of claim 11 wherein the tax data is stored in one or more databases accessible to a server computer executing an international tax planning process operated by the user associated with the paying or receiving company.

15. The method of claim 11 wherein a suggested transaction of the one or more suggested transaction comprises selecting a life-cycle of the transaction among a plurality of possible transaction life-cycles.

16. The method of claim 15 wherein the plurality of possible transaction life-cycles includes export, presence, acquisition, repatriation, and disposition.

17. The method of claim 11 further comprising the step of specifying the payment stream from the source country to the receiving country.

18. The method of claim 17 wherein the payment stream is selected from the group consisting essentially of: interest, dividend, royalty, and sales.

19. The method of claim 17 wherein in a suggested transaction of the one or more suggested transaction comprises routing the transaction through one or more intermediary countries between the source country and the receiving country and where a specified payment stream for any paying country is different from the payment stream to any receiving country.

20. The method of claim 11 further comprising the steps of:
receiving user input regarding a selected strategy of the one or more suggested strategies;
verifying the selected strategy in relation to laws of the source country and the receiving country;
determining the tax cost based on the selected strategy;
obtaining confirmation from an international tax advisor that the strategy should be implemented; and
automatically preparing and causing the filing of all necessary documentations to implement the chosen strategy.

21. A system for determining tax costs associated with an international transaction comprising:
a tax data mining unit configured to retrieve tax data for a sending company located in a source country and a receiving company located in a receiving country;
a transaction analyzer unit configured to provide one or more suggested transactions between the sending company and the receiving company for the routing of goods or services between the sending company and the receiving company;
a first user interface process configured to receive a transaction selection from a user;
a tax calculator configured to determine the amount of the transaction and calculate tax costs associated with the transaction selected by the user; and
a second user interface process configured to provide to the user suggested ideas to minimize the tax costs associated with the transaction.

22. The system of claim 21 wherein the tax data comprises all tax rates needed to calculate the after tax cash on a payment from a source country to a receiving country including mainstream and withholding tax rates.

23. The system of claim 21 wherein the tax data comprises country-specific tax rates and tax laws, and the system further comprises a database storing the tax data and accessible to a server computer executing an international tax planning process operated by the user associated with a multinational group of companies.

24. The system of claim 21 wherein a suggested transaction of the one or more suggested transaction comprises selecting a life-cycle of the transaction among a plurality of possible transaction life-cycles, the plurality of possible transaction life-cycles including export, presence, acquisition, repatriation, and disposition of a good or service.

25. The system of claim 21 further comprising the step of specifying the payment stream from the source country to the receiving country.

26. The system of claim 25 wherein the payment stream is selected from the group consisting essentially of: interest, dividend, royalty, and sales.

27. The system of claim 21 further comprising:
a third user interface process configured to receive user input regarding a selected strategy of the one or more suggested strategies;
a validation unit configured to verify the selected strategy in relation to laws of the source country and the receiving country;
a tax calculation unit configured to determine the amount of the transaction and the impact on worldwide taxes as a result of implementing the suggested transaction;
an output user interface process configured to obtain confirmation from an international tax advisor that the selected strategy should be implemented; and
automatically preparing and causing the filing of all necessary documents to implement the chosen strategy.
